(19) United States
(12) Patent Application Publication
(10) Pub. No.: US 2026/0302868 A1
(43) Pub. Date: Oct. 1, 2026

(54) BRUSH ADJUSTER FOR EXTERNAL EXCITATION OF A ROTOR, WHICH IS ARRANGED ON A ROTOR SHAFT, OF AN ELECTRIC MOTOR, ARRANGEMENT OF A ROTOR SHAFT OF AN ELECTRIC MOTOR AND A WET-RUNNING, ELECTROMAGNETICALLY ACTUABLE BRUSH ADJUSTER, ELECTRIC MOTOR, VEHICLE AND METHOD FOR OPERATING AN ELECTRIC MOTORVEHICLE AND METHOD FOR OPERATING AN ELECTRIC MOTOR

(71) Applicant: Schaeffler Technologies AG & Co. KG, Herzogenaurach (DE)

(72) Inventors: Christof HEEGER, Gelnhausen (DE); Karl Martin FRITSCH, Battenberg (DE); Jens HENRICH, Schmitten (DE)

(21) Appl. No.: 19/477,414

(22) PCT Filed: Mar. 28, 2024
(86) PCT No.: PCT/EP2024/058513

§ 371 Date: Oct. 21, 2025

(30) Foreign Application Priority Data
Apr. 24, 2023 (DE) 10 2023 110 338.5

(51) Int. Cl. H02K 5/14

(52) U.S. Cl. CPC H02K 5/141

(57) ABSTRACT

A brush actuator for external excitation of a rotor of an electric motor arranged on a rotor shaft. The brush actuator has first and second contact brushes each pressable against an associated slip ring of the rotor shaft. The contact brushes can be spring-pretensioned against the slip rings by an armature of an electromagnet and a supporting portion of the electromagnet, the supporting portion interacting with the armature by a spring. By a coil former of the electromagnet, an electromagnetic force acting in or counter to a pretensioning direction of the spring and able to be variably adjusted based on requirement can be impressed onto the armature to increase or attenuate a contact pressure on the contact brushes by the spring and in so doing prevent the contact brushes from lifting off during operation of the electric motor.

### CROSS REFERENCE TO RELATED APPLICATIONS

This is a U.S. national stage of Application No. PCT/EP2024/058513 filed Mar. 28, 2024. Priority is claimed on German Patent Application No. DE 10 2023 110 338.5 filed Apr. 24, 2023, the contents of which are incorporated herein by reference.

### BACKGROUND OF THE INVENTION

### 1. Field of the Invention

The disclosure relates to a brush actuator for external excitation of a rotor of an electric motor, which rotor is arranged on a rotor shaft, to an arrangement of a rotor shaft of an electric motor and a wet-running, electromagnetically actuatable brush actuator for external excitation of a rotor of the electric motor, which rotor is arranged on the rotor shaft. The disclosure also relates to an electric motor, in particular for driving a vehicle, having such an arrangement and to a vehicle having such an electric motor or such an arrangement. The disclosure also relates to a method for operating an electric motor.

### SUMMARY OF THE INVENTION

One aspect of the invention is to ensure reliable external excitation of a rotor of an electric motor. Another aspect of the invention is to ensure said external excitation saves energy.

One aspect of the invention proposes a brush actuator for external excitation of a rotor of an electric motor, which rotor is arranged on a rotor shaft, wherein the brush actuator has a first and a second contact brush, each of which can be pressed against an associated slip ring of the rotor shaft. The contact brushes can be spring-pretensioned against the slip rings by an armature of an electromagnet and a supporting portion of the electromagnet, the supporting portion interacting with the armature by a spring, wherein, by a coil former of the electromagnet, an electromagnetic force acting in or counter to a pretensioning direction of the spring and able to be variably adjusted as required can be impressed onto the armature in order to intensify or lessen a contact pressure or push on the contact brushes by the spring and in so doing prevent the contact brushes from lifting off during operation of the electric motor.

The armature can be articulated against a fork-shaped force distribution element, which can be supported against the slip rings in a manner divided into two arms.

It is suggested here that the contact brushes be in the form of silver graphite brushes.

One aspect of the invention proposes an arrangement composed of a rotor shaft of an electric motor and a wet-running, electromagnetically actuatable brush actuator for external excitation of a rotor of the electric motor, which rotor is arranged on the rotor shaft.

The brush actuator has a first and second contact brush, each of which is pressed or pushed against an associated slip ring of the rotor shaft, wherein the contact brushes are spring-pretensioned against the slip rings by an armature of an electromagnet and a supporting portion of the electromagnet, the supporting portion interacting with the armature by a spring. By a coil former of the electromagnet, an electromagnetic force acting in or counter to a pretensioning direction of the spring and able to be variably adjusted as required can be impressed onto the armature in order to intensify or lessen a contact pressure or push on the contact brushes by the spring and in so doing prevent the contact brushes from lifting off during operation of the electric motor.

The proposed arrangement enables the contact brushes to be pressed or compressed against the slip rings based on requirement. Depending on the requirements, the contact brushes can be pressed or compressed against the slip rings in either a passively spring-pretensioned manner or an actively spring-pretensioned manner.

When the electromagnet is not energized, only a passive or static spring force acts on the contact brushes. This refers to a passive pressing or compressing of the contact brushes by at least one spring or a passive spring pretensioning of the contact brushes.

When the electromagnet is energized, on the other hand, the contact pressure or compression via the at least one spring-depending on the energization of the electromagnet is electromagnetically increased or attenuated by additionally impressing an electromagnetic force on the armature via the coil former of the electromagnet, either in the spring-pretensioning direction and thereby the contact pressure or compression is increased or counter to the spring-pretensioning direction and thereby the contact pressure or compression is attenuated. This impression of the electromagnetic force is requirement-based or variably requirement-based.

This active pressing or compression of the contact brushes is effected in a controlled or regulated manner and in a manner dependent on or taking into account various definable influencing parameters, such as a rotor (shaft) speed, a rotor (shaft) position and/or a vehicle acceleration in the direction of the contact brushes and the like.

In one aspect, the armature is articulated against a fork-shaped force distribution element, which is supported against the slip rings in a manner divided into at least two arms.

This articulated connection of the armature to the fork-shaped force distribution element ensures that the contact brushes are sufficiently pressed against the slip rings, even if the brush actuator is not ideally aligned at right angles to the rotor shaft in its operating position. This is referred to as tilt compensation by way of the brush actuator. This articulated connection of the armature also counteracts different wear on the contact brushes.

In another embodiment, an insulation portion projecting circumferentially in the radial direction of the rotor shaft for forming a sufficient creepage and air path between the current-conducting or current-carrying elements or the slip rings and the contact brushes is provided on the rotor shaft between the slip rings in order to prevent short circuits.

This insulation portion acts in the manner of an advantageous rotor shaft collar, which can advantageously minimize an axial distance between the slip rings and the contact brushes. This rotor shaft collar thus contributes to saving installation space.

In one aspect, the contact brushes are in the form of silver graphite brushes.

The use of such silver graphite brushes in conjunction with slip rings made of iron or steel, for example, can slow down the aging of a gear oil, which wets the contact brushes and slip rings, because flying sparks do not have an aging effect on the gear oil in comparison with copper graphite brushes and slip rings made of copper. In the case of copper graphite brushes and slip rings made of copper, the copper reacts with a sulfur content of the gear oil when sparks fly, causing the gear oil to age. The silver graphite thus improves the durability of the gear oil.

One aspect of the invention proposes an electric motor, in particular for driving a vehicle, having an externally excited rotor arranged on a rotor shaft. In this case, the rotor shaft is combined with a wet-running brush actuator of the type described above for external excitation of the rotor, wherein the brush actuator is attached to a housing of the electric motor and is arranged radially to the rotor shaft, and thereby forms an arrangement of the type described above.

One aspect of the invention proposes a vehicle having an arrangement of the type described above and/or an electric motor of the type described above.

In this case, a vehicle should be understood to mean any type of vehicle or motor vehicle that is operated by way of electric motor, but in particular passenger cars and/or utility vehicles in the form of electric or hybrid vehicles. These may be semi-autonomous or fully autonomous vehicles.

One aspect of the invention proposes a method for operating an electric motor, in which, for external excitation of a rotor of an electric motor, which rotor is arranged on a rotor shaft, at least one first and second contact brush are pressed or compressed against associated slip rings of the rotor shaft. The contact brushes is be spring-pretensioned against the slip rings by an armature of an electromagnet and a supporting portion of the electromagnet, the supporting portion interacting with the armature by a spring, wherein, by a coil former of the electromagnet, an electromagnetic force acting in or counter to a pretensioning direction of the spring and able to be variably adjusted as required is impressed onto the armature in order to intensify or lessen a contact pressure or push on the contact brushes by the spring and in so doing prevent the contact brushes from lifting off during operation of the electric motor.

In one aspect, the contact brushes are passively spring-pretensioned up to a definable limit speed of the rotor shaft and are actively spring-pretensioned above this limit speed and thereby pressed against the associated slip rings based on requirement or variably based on requirement through energization of the electromagnet.

Another aspect proposes that the contact brushes are actively spring-pretensioned up to a definable first limit speed and above a definable second limit speed of the rotor shaft, the second speed being higher than the first, and thereby pressed against the associated slip rings variably based on requirement, wherein the two limit speeds define an intermediate speed range in which the contact brushes are passively spring-pretensioned against the associated slip rings.

Passive in this case means that the electromagnet is not energized, and so only a static spring force acts on the contact brushes. Active, on the other hand, in this case means that this static spring force or this static pressure is electromagnetically increased or attenuated via the spring by virtue of the electromagnet being energized accordingly, and so an electromagnetically adjustable force acting in or counter to the pretensioning direction of the spring is impressed on the armature via the coil former of the electromagnet, and specifically in a requirement-based or variably requirement-based manner, for example taking into account at least one of the above-mentioned influencing parameters, such as a rotor (shaft) speed, a rotor (shaft) position and/or a vehicle acceleration in the direction of the contact brushes and the like.

One aspect of the invention proposes that the first and second limit speeds are stipulated and thus the intermediate speed range is stipulated in such a way that the speeds occurring most frequently according to a driving cycle are covered by said speed range in which the electromagnet is not energized. A WLTC (Worldwide harmonised Light vehicles Test Cycle) can be used as the driving cycle.

### BRIEF DESCRIPTION OF THE DRAWINGS

Further advantages and features may be found in the dependent claims and the exemplary embodiments. In the drawings:

FIG. 1 shows a brush actuator in a first perspective view;

FIG. 2 shows the brush actuator shown in FIG. 1 in a sectional view;

FIG. 3 shows a proposed brush actuator in a perspective view; and

FIG. 4 shows the brush actuator shown in FIG. 3 in a sectional view.

### DETAILED DESCRIPTION OF THE PRESENTLY PREFERRED EMBODIMENTS

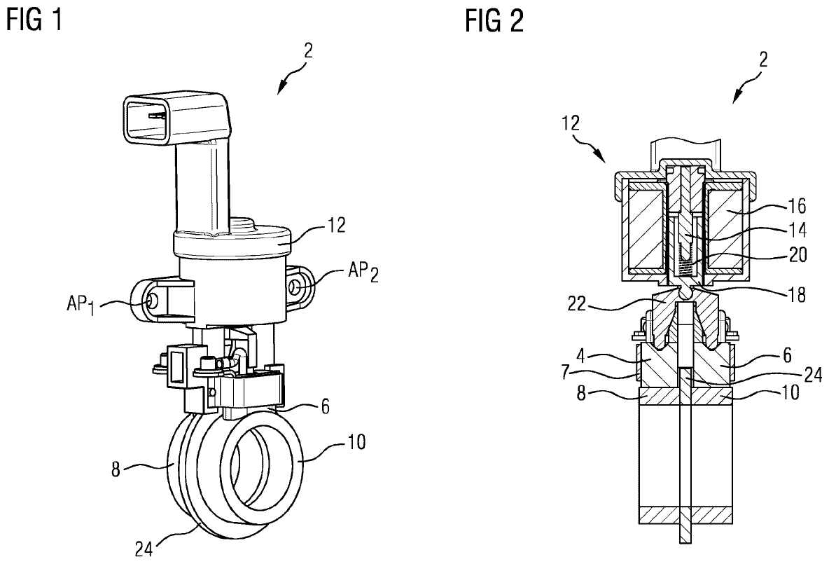

The bidirectional brush actuator 2 illustrated in FIG. 1 and the bidirectional brush module illustrated in FIG. 1 is used for the external excitation of a rotor of an electric motor in the form of a synchronous machine for driving a vehicle, which rotor is arranged on the rotor shaft. The electric motor is combined with a reduction gear, which is lubricated and cooled with oil. The gear oil also lubricates and cools the electric motor and is conveyed within an oil cooling circuit comprising the gear and the electric motor.

This brush actuator 2 is provided or arranged so as to be wet-running in the region of an oil-lubricated bearing point LS of the rotor shaft and provided or arranged radially to the rotor shaft as well as in a stationary manner with respect to a housing of the electric motor. There is no oil seal at this bearing point LS, and so a gear oil can escape from the inside of the housing through the bearing point LS and can reach the brush actuator 2. This arrangement of the brush actuator 2 is closed to the environment by a housing cover—not illustrated here.

The brush actuator 2 is attached or secured to the housing of the electric motor via a first and second mounting point AP₁, AP₂. This brush actuator 2 or the electromagnet 12 of the brush actuator 2 can be electrically contacted, for example, via a socket, which is in the form of a nozzle and molded on a housing of an electromagnet 12.

The brush actuator 2 has a first and second contact brush 4, 6, each of which can be pressed variably against an associated slip ring 8, 10 of the rotor shaft. Each of said two contact brushes 4, 6 is arranged within an associated brush holding and brush guiding element 7 and arranged radially to the rotor shaft so as to be able to move. For example, the contact brush 4 has a negative polarization and the contact brush 6 has a positive polarization.

The contact brushes 4, 6 are spring-pretensioned against the slip rings 8, 10 via a spring 20 in the form of a coil spring in the interior of the electromagnet 12—or a solenoid 12. The spring 20 is arranged between an armature 18 and a bolt or pin 14 of a supporting portion of the electromagnet 12. This supporting portion is arranged to be stationary with respect to the housing of the electromagnet. The armature 18 is arranged largely within a coil former 16 of the electromagnet 12 and to be longitudinally movable with respect to the coil former 16. The armature 18 is also joined to the bolt or pin 14 in sections, which bolt or pin is also largely arranged within the coil former 16 and thereby in stationary manner with respect thereto.

The supporting portion of the electromagnet 12 comprises a cylindrical metallic feedback element made of iron or steel, for example, into which the pin 14 is pressed. The pin 14 itself may also be made of metal.

The armature 18 is in the form of a permanent magnet and can be formed or sprayed from a plastic with magnetic particles, such as ferromagnetic magnetic particles. As an alternative to such a magnetic plastic formation, the armature 18 may be metallic and in this case, for example, be made of ferromagnetic metal or stainless magnetized steel.

The spring 20 thus exerts a nominal or static force of, for example, approximately 30 N on the contact brushes 4, 6. When the electromagnet 12 is not energized, this is the force with which the contact brushes 4, 6 are pressed or compressed against the slip rings 8, 10.

The electromagnet 12 can remain unenergized below a definable limit speed of the rotor shaft of, for example, approximately 800 rpm in order to minimize the total power loss of the brush actuator 2.

This total power loss of the brush actuator 2 results essentially from the friction of the contact brushes 4, 6 on the rotating rotor shaft and the electrical power loss of the electromagnet 12 in the case of a reduction in the contact force. Below this limit speed of approximately 800 rpm, the electrical power loss when the brush actuator 2 is actuated is greater than the friction power savings on the contact brushes 4, 6, which as such—compared to the passive operation of the brush actuator 2—is achieved by a reduced contact force as a result of the actuation of the brush actuator 2. For the sake of completeness, the friction in the electromagnet 12 and the spring 20 should also be mentioned at this point, but these power dissipation components are negligible or play a minor role.

Below this limit speed, the contact brushes 4, 6 are therefore advantageously passively pressed against the slip rings 8, 10.

Above this limit speed, however, an active pressing of the contact brushes 4, 6 against the slip rings 8, 10 can be provided via the armature 18 and the coil former 16 acting on the armature 18, and specifically depending on different definable influencing parameters, such as a rotor (shaft) speed, a rotor (shaft) position, a vehicle acceleration in the direction of the contact brushes 4, 6 and the like, so that an out-of-roundness of the rotor (shaft), floating of the contact brushes 4, 6 on the gear oil wetting the slip rings 8, 10 and/or vibrations and impacts that have an effect on the brush actuator 2 can be counteracted as required. In this case, appropriate energization of the electromagnet 12 can impress a requirement-based electromagnetic force of, for example, up to approximately 50 N onto the armature 18, which force additionally acts on the armature 18 so that the force exerted on the contact brushes 4, 6 can be variably increased to up to approximately 80 N in order to prevent the contact brushes 4, 6 from lifting off during vehicle operation.

The armature 18 is joined to a force distribution element 22, specifically by forming a so-called ball joint. The armature 18 comprises a joint head which has a spherical shape and is enclosed by a complementarily formed portion of the force distribution element 22 or a joint socket or ball socket of the force distribution element 22. The force distribution element 22 may be in the form of an injection-molded plastic element.

The armature 18 is articulated against the force distribution element 22, which is supported against the slip rings 8, 10 in a manner divided into two arms.

An insulation portion 24 made of plastic and projecting circumferentially in the radial direction of the rotor shaft is provided on the rotor shaft and between the slip rings 8, 10 for protection against short circuits. This insulation portion 24 forms a sufficient insulation in the form of a creepage and air path between the slip rings 8, 10. This insulation portion 24 forms a part of the rotor shaft, not shown in FIGS. 1 and 2.

It is proposed to embody the contact brushes 4, 6 in the form of silver graphite brushes, which improves the durability of the gear oil.

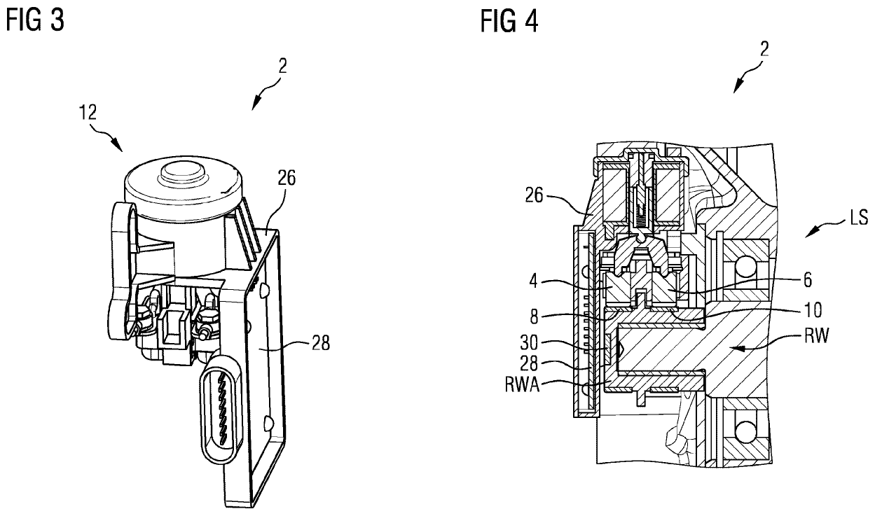

According to FIGS. 3 and 4, the brush actuator 2 also has a printed circuit board 28 (also referred to as a PCB) via which the brush actuator 2 or the electromagnet 12 of the brush actuator 2 can be electrically contacted via a socket illustrated in FIG. 3.

This printed circuit board 28 has a rotor shaft position sensor and/or an acceleration sensor. The printed circuit board 28 is housed by a plastic housing portion 26, which is formed on a plastic housing portion of the electromagnet 12 and extends transversely, preferably orthogonally, to the rotor shaft RW and up to an area around a front side of one end of the rotor shaft RW, so that the printed circuit board 28 is arranged transversely, preferably orthogonally, to the rotor shaft RW and in this case opposite the end of the rotor shaft RW such that the printed circuit board 28 covers an area around the front side of the end of the rotor shaft RW in order to be able to interact, for example inductively, with said front side.

In this embodiment of the brush actuator 2, too, the arrangement proposed here must be imagined as being closed from the environment by way of a housing cover—not illustrated here.

FIG. 4 illustrates a metallic end of the rotor shaft RW with a rotor shaft portion RWA made of plastic which is arranged thereon and can be pushed or sprayed onto the end of the rotor shaft RW. In this plastic there are embedded metal contacting elements configured as two slip rings 8, 10 and a conductor track which is associated with the respective slip ring 8, 10 and which extends from the associated slip ring 8, 10 through the plastic portion in the direction of the externally excited rotor RW (not shown here) arranged on the rotor shaft.

The slip ring 8 is pot-like and in this case formed for example as a so-called deep-drawn part, wherein the bottom of the pot forms a front-side metal portion 30—of which only part is illustrated in FIG. 4—of the end of the rotor shaft RW in order to be able to interact with a, for example, inductive signal transmitter of the printed circuit board 28.

This bottom of the pot or this front-side metal portion 30 of the slip ring 8 must be imagined as having interruptions in the circumferential direction of the slip ring 8, which as such can be filled with the plastic. Between two adjacent interruptions or recesses of this pot bottom is a metal web-shaped portion which is formed to the outer closed circumferential portion of the slip ring 8 which interacts with the contact brush 4.

The rotor shaft portion RWS according to FIG. 4 thus implements two functions. It is used on the one hand to externally excite the rotor of the rotor shaft RW and on the other hand to detect the position of the externally excited rotor. The slip ring 8 combines two functions in one component. On the one hand, it acts as a contacting element with the contact brush 4 and on the other hand as a transmitter wheel with the inductive signal transmitter of the printed circuit board 28. When interacting with the signal transmitter, periodic or sine-cosine-shaped voltage signals are generated from which an absolute angular orientation or angular position of the rotor relative to a stator of the synchronous machine can be determined in a control unit, so that the synchronous machine can be commutated efficiently.

An acceleration sensor can also be provided on the printed circuit board 28 and used to determine vehicle accelerations in the direction of the contact brushes 4, 6—due to shocks and vibrations. In addition to other vehicle parameters, these vehicle accelerations can be used to adjust the contact pressure of the contact brushes 4, 6. In addition or as an alternative, vehicle acceleration information can be tapped, for example also on a drive axle of the vehicle, and provided via a CAN bus, to which the brush actuator 2 proposed here is connected via the printed circuit board 28 in order to be able to counter such vehicle accelerations with the brush actuator 2.

And since vehicle accelerations in the direction of the contact brushes 4, 6—due to impacts and vibrations—can be compensated by a correspondingly active pressing of the contact brushes 4, 6, the number of contact brushes 4, 6 required for external excitation can be reduced to a pair.

The brush actuator 2 illustrated in FIGS. 1 to 4 takes up only a small amount of installation space in the axial direction of the rotor shaft RW. It is also easy to mount onto the housing of the electric motor and can be mounted radially to the rotor shaft.

The brush actuator 2 according to FIGS. 3 and 4 differs from the brush actuator 2 according to FIGS. 1 and 2 only by the added printed circuit board 28 and the plastic housing portion 26 housing same and the plastic receiving portion with receiving points and also molded on the plastic housing portion of the electromagnet 12, via which points the brush actuator 2 is attached or can be attached to the housing of the electric motor—and radially to the rotor shaft RW.

By way of the active pressing or compression of the contact brushes 4, 6 against the assigned slip rings 8, 10 proposed in the context of this disclosure, a slip contact friction or a slip contact friction power can advantageously be reduced to a necessary minimum depending on the need compared to a purely passive system in which a spring force for pressing or compressing the contact brushes based on a maximum rotor shaft speed is determined. This also advantageously results in reduced or lower brush wear. This also reduces the power consumption of the electric motor, so that a range of a battery supplying the electric motor is increased.

In this case, the contact pressure or compression via the spring 20 can be lessened to a definable first limit speed of the rotor shaft and increased above a definable second limit speed of the rotor shaft, the second speed being higher than the first. On the other hand, the electromagnet 12 can remain unenergized above the first limit speed and up to the second limit speed, which define a speed range.

It is proposed that the first and second speed limits be defined or stipulated in such a way and that this speed range defined by them or between them be defined in such a way that the speeds occurring most frequently in a driving cycle—for example in the form of a WLTC (Worldwide harmonised Light vehicles Test Cycle)—are covered by this speed range, in which the electromagnet can remain unenergized. This results in a minimum power requirement for active pressing or compression of the contact brushes 4, 6 over the lifetime of the vehicle mentioned at the beginning.

As an alternative to the electromagnet 12 illustrated in FIGS. 1 to 4, in which the coil former 16 is in the form of a stator and acts on armature 18 in the form of a permanent magnet and which is on the inside of the coil former and encompassed thereby, the electromagnet may also be in the form of an immersion coil, not illustrated here, the armature of which is in the form of a coil former which, as such, is immersed in a stator in the form of a permanent magnet and is designed to be longitudinally movable with respect thereto.

Although exemplary embodiments are explained in the above description, it is pointed out that numerous modifications are possible. Furthermore, it is pointed out that the exemplary embodiments are only examples that are in no way intended to limit the scope of protection, the applications and the structure. Instead, the above description gives a person skilled in the art a guideline for implementing at least one exemplary embodiment, it being possible to make various changes, especially with regard to the function and arrangement of the component parts described, without departing from the scope of protection as will become apparent from the claims and combinations of features that are equivalent thereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A brush actuator for external excitation of a rotor arranged on a rotor shaft of an electric motor, the brush actuator comprising:
a first and a second contact brush, each of which configured to be pressed against an associated slip ring of the rotor shaft;
wherein the first and second contact brushes are configured to be spring-pretensioned against the slip rings by an armature of an electromagnet and a supporting portion of the electromagnet, the supporting portion interacting with the armature by a spring;
wherein, by a coil former of the electromagnet, an electromagnetic force acting in or counter to a pretensioning direction of the spring and able to be adjusted variably based on requirement can be impressed onto the armature to increase or attenuate a contact pressure on the first and second contact brushes by the spring and in so doing prevent the first and second contact brushes from lifting off during operation of the electric motor.

17. The brush actuator as claimed in claim 16, wherein the armature is articulated against a fork-shaped force distribution element, which can be supported against the slip rings in a manner divided into two arms.

18. The brush actuator as claimed in claim 16, wherein the first and second contact brushes are silver graphite brushes.

19. An arrangement comprising:
a rotor shaft of an electric motor and
a wet-running, electromagnetically actuatable brush actuator for external excitation of a rotor of the electric motor, which is arranged on the rotor shaft, the brush actuator comprising:
a first and a second contact brush, each of which is pressed against an associated slip ring of the rotor shaft,
wherein the first and second contact brushes are spring-pretensioned against the slip rings by an armature of an electromagnet and a supporting portion of the electromagnet, the supporting portion interacting with the armature by a spring,
wherein, by a coil former of the electromagnet, an electromagnetic force acting in or counter to a pretensioning direction of the spring and able to be adjusted variably based on requirement can be impressed onto the armature to increase or attenuate a contact pressure on the first and second contact brushes by the spring and in so doing prevent the first and second contact brushes from lifting off during operation of the electric motor.

20. The arrangement as claimed in claim 19, wherein the armature is articulated against a fork-shaped force distribution element, which is supported against the slip rings in a manner divided into two arms.

21. The arrangement as claimed in claim 19, further comprising an insulation portion projecting circumferentially in a radial direction of the rotor shaft for forming a sufficient creepage and air path between the slip rings and arranged on the rotor shaft between the slip rings.

22. The arrangement as claimed in claim 19, wherein the first and second contact brushes are silver graphite brushes.

23. An electric motor, for driving a vehicle, having an externally excited rotor arranged on a rotor shaft, wherein the rotor shaft is combined with a wet-running brush actuator comprising:
a first and a second contact brush, each of which configured to be pressed against an associated slip ring of the rotor shaft;
wherein the contact brushes are configured to be spring-pretensioned against the slip rings by an armature of an electromagnet and a supporting portion of the electromagnet, the supporting portion interacting with the armature by a spring;
wherein, by a coil former of the electromagnet, an electromagnetic force acting in or counter to a pretensioning direction of the spring and able to be adjusted variably based on requirement can be impressed onto the armature to increase or attenuate a contact pressure on the first and second contact brushes by the spring and in so doing prevent the first and second contact brushes from lifting off during operation of the electric motor.

24. A vehicle having an arrangement comprising:
a rotor shaft of an electric motor and
a wet-running, electromagnetically actuatable brush actuator for external excitation of a rotor of the electric motor, which is arranged on the rotor shaft, the brush actuator comprising:
a first and a second contact brush, each of which is pressed against an associated slip ring of the rotor shaft,
wherein the first and second contact brushes are spring-pretensioned against the slip rings by an armature of an electromagnet and a supporting portion of the electromagnet, the supporting portion interacting with the armature by a spring,
wherein, by a coil former of the electromagnet, an electromagnetic force acting in or counter to a pretensioning direction of the spring and able to be adjusted variably based on requirement can be impressed onto the armature to increase or attenuate a contact pressure on the first and second contact brushes by the spring and in so doing prevent the first and second contact brushes from lifting off during operation of the electric motor.

25. A method for operating an electric motor, in which, for external excitation of a rotor of the electric motor, which rotor is arranged on a rotor shaft,
pressing at least one first contact brush and at least one second contact brush are against associated slip rings of the rotor shaft,
spring pretensioning the at least one first and second contact brushes against the slip rings by an armature of an electromagnet and a supporting portion of the electromagnet, the supporting portion interacting with the armature by a spring,
wherein, by a coil former of the electromagnet, an electromagnetic force acting in or counter to a pretensioning direction of the spring and able to be adjusted variably based on requirement is impressed onto the armature in order to increase or attenuate a contact pressure on the contact brushes by the spring and in so doing prevent the contact brushes from lifting off during operation of the electric motor.

26. The method as claimed in claim 25, wherein the contact brushes are passively spring-pretensioned up to a definable limit speed of the rotor shaft and are actively spring-pretensioned above this limit speed and thereby pressed against the associated slip rings variably based on requirement through energization of the electromagnet.

27. The method as claimed in claim 25, wherein the contact brushes are actively spring-pretensioned up to a definable first limit speed and above a definable second limit speed of the rotor shaft, the second speed being higher than the first, and thereby pressed against the associated slip rings variably based on requirement, wherein the two limit speeds define an intermediate speed range in which the contact brushes are passively spring-pretensioned against the associated slip rings.

28. The method as claimed in claim 27, wherein the first and second limit speeds are stipulated and thus the intermediate speed range is stipulated in such a way that the speeds occurring most frequently according to a driving cycle are covered by the speed range in which the electromagnet is not energized.

29. The method as claimed in claim 28, wherein a WLTC driving cycleTC=Worldwide harmonised Light duty Test Cycle) is used as the driving cycle.

30. The method as claimed in any one of claims 25, wherein the contact pressure via the spring is increased or attenuated taking into account a rotor speed, a rotor position and/or a vehicle acceleration in the direction of the contact brushes.
